(19) United States
(12) Patent Application Publication
(10) Pub. No.: US 2011/0302994 A1
(43) Pub. Date: Dec. 15, 2011

(54) Components Suitable for Use in Devices Such as an Evaporative Light Scattering Detector

(76) Inventors: James M. Anderson, JR., Arlington Heights, IL (US); Josef P. Bystron, Chicago, IL (US); Washington J. Mendoza, Lakes in the Hills, IL (US); Raaidah Saari-Nordhaus, Antioch, IL (US)

(21) Appl. No.: 13/133,837

(22) PCT Filed: Dec. 10, 2009
(86) PCT No.: PCT/US09/06492

§ 371 Date: Aug. 29, 2011

Related U.S. Application Data
(60) Provisional application No. 61/201,348, filed on Dec. 10, 2008.

(51) Int. Cl. G01N 30/02

(52) U.S. Cl. 73/23.35

(57) ABSTRACT

Components suitable for use in devices such as an evaporative light scattering detector are disclosed. Methods of making and using components suitable for use in devices such as an evaporative light scattering detector are also disclosed.

### FIELD OF THE INVENTION

The present invention is directed to a variety of components suitable for use in analytical devices such as an evaporative light scattering detector (ELSD). The present invention is also directed to methods of making and using a variety of components such as in an evaporative light scattering detector (ELSD) device.

### BACKGROUND OF THE INVENTION

There is a need in the art for various components suitable for use in analytical devices, such as an evaporative light scattering detector (ELSD), so as to provide improved device performance.

### SUMMARY OF THE INVENTION

The present invention addresses some of the difficulties and problems discussed above by the discovery of components suitable for use in analytical devices including, but not limited to, an evaporative light scattering detector (ELSD). The components of the present invention provide one or more advantages over known components used in analytical devices. The one or more advantages may include, but are not limited to, the ability to eliminate one or more gas (e.g., nitrogen) cylinders from a work area when operating an analytical device comprising a nebulizer; the ability to provide a continuous supply of air to a nebulizer of an analytical device; the ability to effectively and efficiently remove particle build-up and/or burnt material from an interior surface of a drift tube of an analytical device; the ability to maintain a maximum operating temperature (e.g., about 50° C.) of a drift tube of an analytical device; the ability to effectively and efficiently adjust flow properties through a drift tube of an analytical device; the ability to effectively and efficiently trap condensate within a drain trap of an analytical device; and the ability to actively drain condensate within a drain trap of an analytical device.

In one exemplary embodiment, the component of the present invention comprises an air pump positioned within a detector housing of a detector, wherein the air pump is operatively adapted to supply compressed air to a nebulizer of the detector. The air pump enables the removal of any gas cylinders, typically used to provide gas to a nebulizer, from a work area so as to (i) reduce space requirements, (ii) reduce some operating costs associated with the gas cylinders, (iii) reduce down time associated with replacing empty cylinders, (iv) reduce operator concern regarding the possibility of running out of a gas source, and (v) improve lab safety.

In another exemplary embodiment, the component of the present invention comprises a drift tube assembly comprising a drift tube having a first end, a second end, an inner drift tube surface facing an interior of the drift tube, and an outer surface; and at least one removable tubular liner, wherein each removable tubular liner has a first liner end, a second liner end, an inner liner surface facing an interior of the removable tubular liner, and an outer liner surface. Each of the removable tubular liners is positionable within the drift tube so that the outer liner surface of each removable tubular liner extends along the inner drift tube surface. The removable tubular liner(s) enables quick clean-up of a given drift tube, as well as the ability to quickly and effectively change an inner cross-sectional area of a drift tube, and thereby increase or decrease fluid flow through the drift tube as desired for various applications.

In a further exemplary embodiment, the component of the present invention comprises an active condensate drain trap positioned within a detector housing of a detector. The active condensate drain trap is operatively adapted to be actively drained via a condensate pump or an evaporator positioned within the detector housing. The active condensate drain trap enables removal of condensate from a detector with minimal or no operator intervention.

The present invention is further directed to devices containing one or more of the herein disclosed components. Devices may include, but are not limited, to analytical devices, aerosol-based detectors, an evaporative light scattering detector (ELSD), a condensation nucleation light scattering detector (CNLSD), a charged aerosol detector (CAD), or a mass spectrometer (MS). In some embodiments, the device containing one or more of the herein disclosed components is incorporated into a chromatography system, such as a flash chromatography system.

In one exemplary embodiment, the device of the present invention comprises a detector suitable for use in chromatography applications, wherein the detector comprises (i) a detector housing; (ii) a nebulizer positioned within the detector housing; and (iii) an air pump positioned within the detector housing, the air pump being operatively adapted to supply compressed air to the nebulizer. The exemplary detector may further comprise the herein disclosed drift tube assembly and/or active condensate drain trap. Further, the resulting detector may be incorporated into a chromatography system, such as a flash chromatography system.

In another exemplary embodiment, the device of the present invention comprises a detector suitable for use in chromatography applications, wherein the detector comprises (i) a detector housing; and (ii) a drift tube assembly positioned within the detector housing, wherein the drift tube assembly comprises a drift tube having a first end, a second end, an inner drift tube surface facing an interior of said the tube, and an outer surface; and at least one removable tubular liner, each removable tubular liner having a first liner end, a second liner end, an inner liner surface facing an interior of the removable tubular liner, and an outer liner surface, wherein each of the removable tubular liners is positionable within the drift tube so that the outer liner surface of the removable tubular liner extends along the inner drift tube surface. The exemplary detector may further comprise the herein disclosed air pump and/or active condensate drain trap. Further, the resulting detector may be incorporated into a chromatography system, such as a flash chromatography system.

In yet another exemplary embodiment, the device of the present invention comprises a detector suitable for use in chromatography applications, wherein the detector comprises (i) a detector housing; and (ii) an active condensate drain trap positioned within the detector housing, the active condensate drain trap being operatively adapted to actively drain via a condensate pump or an evaporator positioned within the detector housing. The exemplary detector may further comprise the herein disclosed air pump and/or drift tube assembly. Further, the resulting detector may be incorporated into a chromatography system, such as a flash chromatography system.

The present invention is also directed to methods of making one or more of the above-described components of the present invention, as well as one or more of the above-described devices of the present invention. One or more of the above-described components of the present invention may be incorporated into a device housing of a device, for example, a device operatively adapated to perform an analytical test method step or steps, such as a method of analyzing a test sample that potentially contains at least one analyte.

In one exemplary embodiment, the method of making a device of the present invention comprises a method of making a detector suitable for use in chromatography applications, wherein the method comprises incorporating (1) an air pump within a detector housing of the detector, the air pump being operatively adapted to supply compressed air to a nebulizer positioned within the detector housing; (2) a drift tube assembly within the detector housing, wherein the drift tube assembly comprises (i) a drift tube having a first end, a second end, an inner drift tube surface facing an interior of said drift tube, and an outer surface; and (ii) at least one removable tubular liner, each removable tubular liner having a first liner end, a second liner end, an inner liner surface facing an interior of the removable tubular liner, and an outer liner surface, wherein each of the removable tubular liners is positionable within the drift tube so that the outer liner surface of the removable tubular liner extends along the inner drift tube surface; (3) an active condensate drain trap within the detector housing, the active condensate drain trap being operatively adapted to actively drain via a condensate pump or an evaporator positioned within the detector housing; or (4) any combination of (1) to (3).

The present invention is further directed to methods of using one or more of the above-described components of the present invention, as well as one or more of the above-described devices of the present invention. Methods of using one or more of the above-described components of the present invention may comprise using one or more of the above-described components within a device, for example, a device operatively adapated to perform an analytical test method step or steps, such as a method of analyzing a test sample that potentially contains at least one analyte.

In one exemplary embodiment, the method of using one or more of the above-described components of the present invention comprises using one or more of the above-described components within a detector, such as an evaporative light scattering detector (ELSD), and using the ELSD in a flash chromatography system.

These and other features and advantages of the present invention will become apparent after a review of the following detailed description of the disclosed embodiments and the appended claims.

### BRIEF DESCRIPTION OF THE FIGURES

FIG. 1 depicts an exemplary device of the present invention;

FIG. 2A depicts a view of an exemplary drift tube assembly suitable for use in the exemplary device shown in FIG. 1;

FIG. 2B depicts a view of the exemplary drift tube assembly of FIG. 2A when an exemplary tubular liner is partially inserted into the exemplary drift tube;

FIG. 3A depicts a cross-sectional view of the exemplary drift tube assembly shown in FIG. 2B along line A-A when a first removable tubular liner is used in combination with a drift tube;

FIG. 3B depicts a cross-sectional view of the exemplary drift tube assembly shown in FIG. 2B along line A-A when a second removable tubular liner is used in combination with the drift tube;

FIG. 4 depicts a view of an exemplary drift tube assembly in combination with a nebulizer and exemplary cartridge positioned between the nebulizer and the exemplary drift tube assembly;

FIG. 5A depicts a view of an exemplary tubular liner attached to an exemplary cartridge and partially inserted into an exemplary drift tube connected to an optics block;

FIG. 5B depicts a cross-sectional view of an exemplary tubular liner attached to an exemplary cartridge and fully inserted into an exemplary drift tube connected to an optics block; and

FIG. 6 depicts another exemplary device of the present invention.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

It must be noted that as used herein and in the appended claims, the singular forms “a”, “and”, and “the” include plural referents unless the context clearly dictates otherwise. Thus, for example, reference to “a solvent” includes a plurality of such solvents and reference to “solvent” includes reference to one or more solvents and equivalents thereof known to those skilled in the art, and so forth.

“About” modifying, for example, the quantity of an ingredient in a composition, concentrations, volumes, process temperatures, process times, recoveries or yields, flow rates, and like values, and ranges thereof, employed in describing the embodiments of the disclosure, refers to variation in the numerical quantity that may occur, for example, through typical measuring and handling procedures; through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

As used herein, the term “chromatography” means a physical method of separation in which the components to be separated are distributed between two phases, one of which is stationary (stationary phase) while the other (the mobile phase) moves in a definite direction.

As used herein, the term “liquid chromatography” means the separation of mixtures by passing a fluid mixture dissolved in a “mobile phase” through a column comprising a stationary phase, which separates the analyte (i.e., the target substance) from other molecules in the mixture and allows it to be isolated.

As used herein, the term “mobile phase” means a fluid liquid, a gas, or a supercritical fluid that comprises the sample being separated and/or analyzed and the solvent that moves the sample comprising the analyte through the column. The mobile phase moves through the chromatography column or cartridge (i.e., the container housing the stationary phase) where the analyte in the sample interacts with the stationary phase and is separated from the sample.

As used herein, the term “stationary phase” or “media” means material fixed in the column or cartridge that selectively adsorbs the analyte from the sample in the mobile phase separation of mixtures by passing a fluid mixture dissolved in a “mobile phase” through a column comprising a stationary phase, which separates the analyte to be measured from other molecules in the mixture and allows it to be isolated.

As used herein, the term “flash chromatography” means the separation of mixtures by passing a fluid mixture dissolved in a “mobile phase” under pressure through a column comprising a stationary phase, which separates the analyte (i.e., the target substance) from other molecules in the mixture and allows it to be isolated.

As used herein, the term “fluid” means a gas, liquid, and supercritical fluid.

As used herein, the term “substantially” means within a reasonable amount, but includes amounts which vary from about 0% to about 50% of the absolute value, from about 0% to about 40%, from about 0% to about 30%, from about 0% to about 20% or from about 0% to about 10%.

The present invention is directed to a variety of components suitable for use in analytical devices including, but not limited to, an evaporative light scattering detector (ELSD), a condensation nucleation light scattering detector (CNLSD), a charged aerosol detector (e.g., a corona CAD), and a mass spectrometer. In one desired embodiment of the present invention, one or more of the disclosed components are incorporated into an evaporative light scattering detector (ELSD) apparatus. A description of suitable evaporative light scattering detectors (ELSD) and components used therein may be found in, for example, U.S. Pat. Nos. 6,229,605 and 6,362,880, the subject matter of both of which is hereby incorporated herein by reference in their entirety.

The present invention is further directed to methods of making a variety of components suitable for use in analytical devices, such as an ELSD apparatus. The present invention is even further directed to methods of using one or more of the disclosed components in an analytical device, such as in an evaporative light scattering detector (ELSD) device, in order to contribute to the performance of one or more functions of the device.

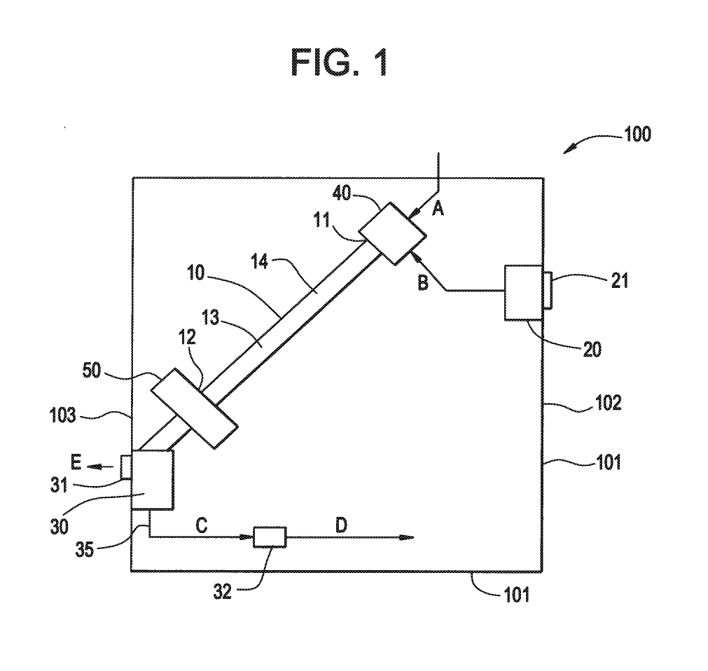

In one exemplary embodiment, one or more of the disclosed components of the present invention are incorporated into a device such as the exemplary detector shown in FIG. 1. As shown in FIG. 1, exemplary detector 100 comprises a detector housing 101 and the following components positioned within detector housing 101: drift tube assembly 10, air pump 20, nebulizer 40, optics block 50, active condensate drain trap 30, and condensate pump 32. In exemplary detector 100, column effluent (including solvent and sample/analyte) travels along arrow A into nebulizer 40. Compressed air from air pump 20 is introduced into nebulizer 40 as shown by arrow B. Nebulized material travels through drift tube assembly 10 and solvent is evaporated, which allows the sample to be isolated in the air stream, and then the mixture proceeds to optics block 50, where the sample is exposed to light energy, which generates an electrical signal. The mixture of evaporated solvent and sample exiting optics block 50 is condensed and trapped within active condensate drain trap 30. In exemplary detector 100, condensate pump 32 actively removes condensate (not shown) that accumulates within active condensate drain trap 30 through drain opening 35, along arrow C, though condensate pump 32, and along arrow D to a waste disposal container or line (not shown).

As shown in FIG. 1, the various components of the present invention may be combined with one another to form devices such as detectors (or used separately to form detectors or other devices). A description of the various components of the present invention and various component configurations for use in devices is provided below.

### I. Components

The present invention is directed to the following individual components, which may be used alone or in combination with one another to contribute to the performance of known analytical devices.

A. Integrated Air Pump

The present invention is directed to integrated air pumps such as exemplary integrated air pump 20 shown in FIG. 1. As shown in FIG. 1, air pump 20 may be positioned within detector housing 101 of a detector, such as exemplary detector 100. Air pump 20 is operatively adapted to supply compressed air to nebulizer 40 of exemplary detector 100. In exemplary detector 100, air pump 20 is positioned along a wall 102 of detector housing 101 with an air inlet 21 positioned through wall 102. However, it should be understood that air pump 20 may be positioned at any location within detector housing 101.

Air pump 20 provides a desired flow rate of compressed air to nebulizer 40 of exemplary detector 100. Example of a suitable air pump includes Swing Piston Compressor Pump, commercially available from KNF Neuberger Inc.

B. Drift Tube Assembly

The present invention is also directed to drift tube assemblies such as exemplary drift tube assembly 10 shown in FIG. 1. The drift tube assemblies of the present invention may be used in an ELSD apparatus or in any other analytical device (e.g., in a charged aerosol detector (e.g., a corona CAD) apparatus or a mass spectrometer).

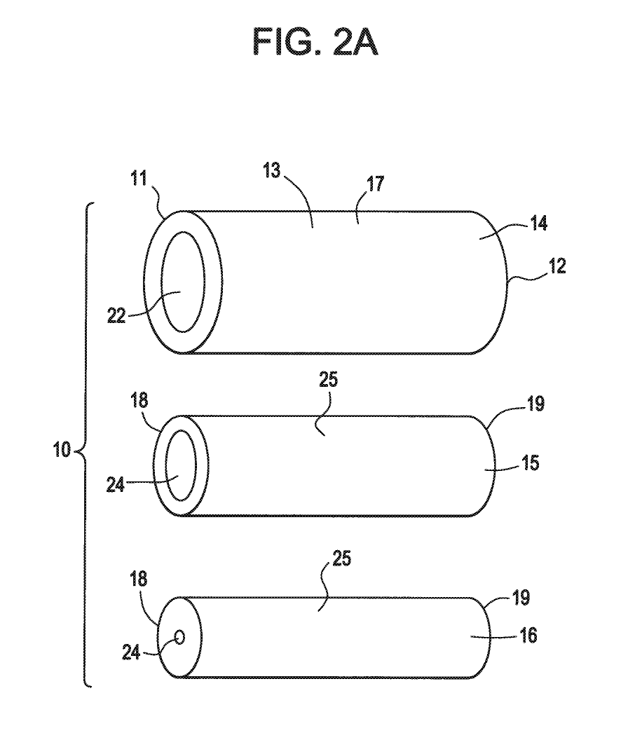

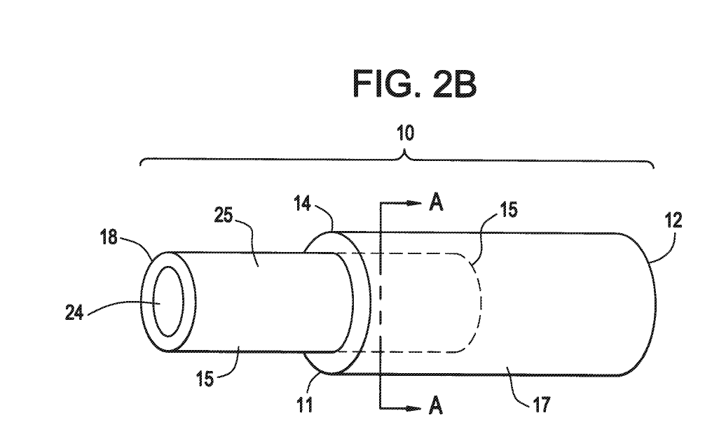

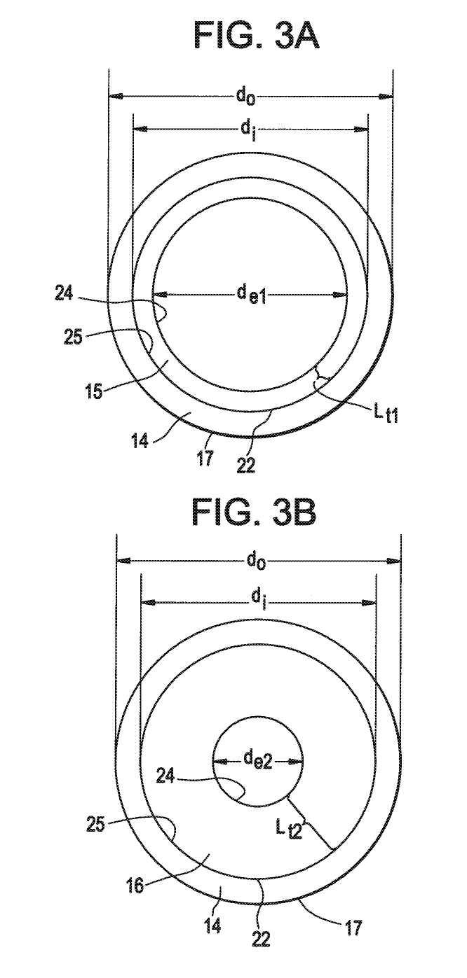

As shown in FIGS. 2A-2B, exemplary drift tube assembly 10 comprises (1) a drift tube 14 having a first end 11, a second end 12, a tubular structure 13 extending a distance between first end 11 and second end 12, and an interior surface 22 (also shown in FIGS. 3A-3B) surrounded by tubular structure 13; and (2) one or more tubular liners 15 and 16.

1. Drift Tube

Exemplary drift tube assembly 10 comprises drift tube 14 having tubular structure 13 having one or more concentric layers. Each of the one or more concentric layers may provide a desired feature (e.g., structural integrity, high temperature resistance, etc.) to the resulting drift tube 14. Further, each of the one or more concentric layers has a layer thickness and is formed from one or more layer materials in order to provide specific features (e.g., chemical inertness, etc.) to the resulting drift tube 14.

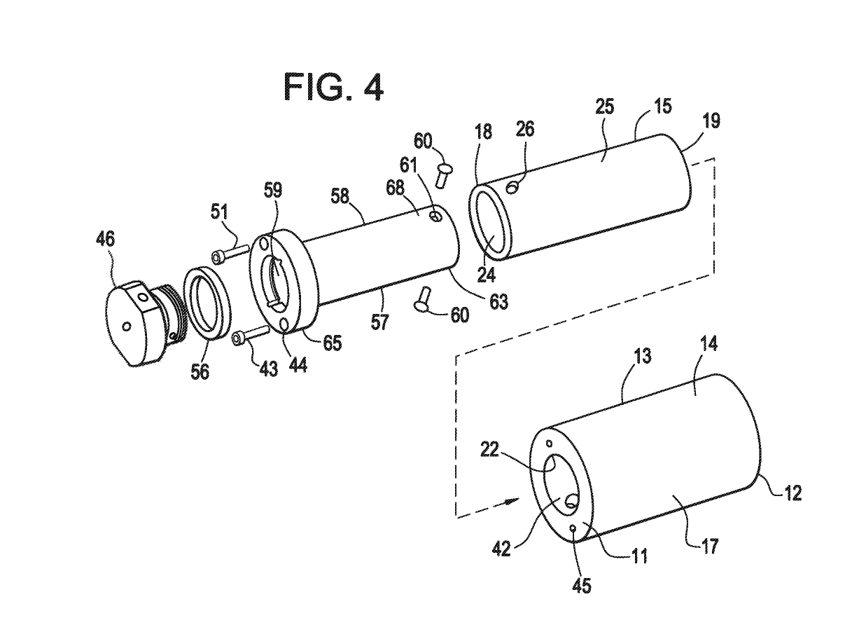

Tubular structure 13 may further comprise attachment features proximate first end 11 and second end 12. Attachment features may be used to connect exemplary drift tube 14 to one or more components of a given device (e.g., nebulizer 40, a cartridge component (described below), and/or optics block 50). Suitable attachment features include, but are not limited to, threads (not shown) so that exemplary drift tube 14 can be attached to corresponding threads on one or more components of a given device; a flange (not shown) containing one or more holes therein so that exemplary drift tube 14 can be attached to one or more components of a given device via bolts or screws extending through the one or more holes; one or more holes within tubular structure 13 at first end 11 and/or second end 12 so that exemplary drift tube 14 can be attached to one or more components of a given device via bolts or screws extending into the one or more holes (see, for example, holes 45 in first end 11 of tubular structure 13 shown in FIG. 4); and a clamping member (not shown) that can be used to attach exemplary drift tube 14 to one or more components of a given device via corresponding clamping members.

Tubular structure 13 may comprise one or more concentric layers of material. In one exemplary embodiment, tubular structure 13 comprises a material that provides good heat conductive properties to exemplary drift tube 14. For example, tubular structure 13 may comprise a metal, such as copper, so that when heat is applied to outer surface 17 of tubular structure 13, a substantially uniform amount of heat is conducted along outer surface 17 and to interior surface 22. In one exemplary embodiment, tubular structure 13 comprises a layer of copper electroplated to an inner layer formed from stainless steel. In a further exemplary embodiment, tubular structure 13 comprises a preformed sleeve of copper fitted over an inner layer formed from stainless steel.

In further exemplary embodiments, tubular structure 13 may further comprise an optional insulating material (not shown) that provides insulative properties to one or more inner layers of exemplary drift tube 14. For example, tubular structure 13 may comprise an outer foam insulation layer, such as polyurethane foam, so as to insulate one or more inner layers. This exemplary embodiment is particularly useful when exemplary drift tube 14 is utilized as a drift tube in an ELSD apparatus.

In a further exemplary embodiment, tubular structure 13 may further comprise an optional outermost clear coat material (not shown) applied over a portion of or substantially all of outer surface 17 so as to provide, for example, enhanced chemical resistance. The clear coat material may comprise any clear coat material including, but not limited to, polyurethane materials. Typically, when present, the clear coat layer has an average layer thickness of from about 0.01 to about 0.5 mm.

Typically, tubular structure 13 has an overall average thickness of from about 0.10 mm (0.004 in) to about 50.8 mm (2 in). In one exemplary embodiment, tubular structure 13 comprises a copper layer and has an average layer thickness of about 0.76 mm (0.03 in) to about 1.52 mm (0.6 in). In another embodiment, tubular structure 13 comprises a copper layer and has a thickness from about 2.54 mm (0.10 in) to about 7.62 mm (0.30 in) (more desirably, about 6.35 mm (0.25 in)).

Tubular structure 13 has an inlet cross-sectional flow area at first end 11, an outlet cross-sectional flow area at second end 12 of tubular wall structure 13, and a tubular cross-sectional flow area between first end 11 and second end 12. In one exemplary embodiment of the present invention, the tubular cross-sectional flow area is substantially equal to the inlet cross-sectional flow area, the outlet cross-sectional flow area, or both. In a further exemplary embodiment of the present invention, the tubular cross-sectional flow area is substantially equal to both the inlet cross-sectional flow area and the outlet cross-sectional flow area.

Each of the tubular cross-sectional flow area, the inlet cross-sectional flow area and the outlet cross-sectional flow area may have any desired cross-sectional configuration. Suitable cross-sectional configurations include, but are not limited to, circular, rectangular, square, pentagon, triangular, and hexagonal cross-sectional configurations. In one desired embodiment, each of the tubular cross-sectional flow area, the inlet cross-sectional flow area, and the outlet cross-sectional flow area has a circular cross-sectional flow area.

Drift tubes of the present invention may have a variety of sizes depending on the use of the tubular member. For example, when the drift tube of the present invention is to be used in an ELSD apparatus, the drift tube typically has an overall length of up to about 50.8 cm (20 in), and more typically, within a range of about 20.32 cm (8 in) to about 40.64 cm (16 in). In one desired embodiment, the drift tube of the present invention is used in an ELSD apparatus, and has an overall length of about 27.94 cm (11 in). However, it should be understood that there is no limitation on the overall dimensions of the disclosed drift tubes.

As described above, drift tube 14 may have a tubular cross-sectional flow area, an inlet cross-sectional flow area, and an outlet cross-sectional flow area. Each of the tubular cross-sectional flow area, the inlet cross-sectional flow area, and the outlet cross-sectional flow area may vary in size depending on the use of a given drift tube 14. Typically, each of the tubular cross-sectional flow area, the inlet cross-sectional flow area, and the outlet cross-sectional flow area is independently up to about 506 cm² (78.5 in²). In one desired embodiment, drift tube 14 of the present invention is used in an ELSD apparatus, and each of the tubular cross-sectional flow area, the inlet cross-sectional flow area, and the outlet cross-sectional flow area is about 3.84 cm² (0.59 in²). However, as mentioned above, there is no limitation on the overall dimensions of the disclosed drift tubes.

Drift tubes (and cartridges used therewith) may be constructed from materials in order to withstand an internal pressure that varies depending on the end use of a given component. Typically, drift tubes (and cartridges used therewith) of the present invention are constructed to have a pressure capacity of up to about 15,000 psig. In some embodiments, drift tubes (and cartridges used therewith) of the present invention are constructed to have a pressure capacity ranging from about 500 to about 5,000 psig.

Drift tubes of the present invention may further comprise one or more additional components that are not shown in FIGS. 1 and 2A. Suitable additional components include, but are not limited to, one or more temperature sensors positioned along a length of exemplary drift tube 14, one or more optional heating elements positioned along a length of exemplary drift tube 14, and one or more grounding screws positioned along a length of exemplary drift tube 14.

2. Tubular Liners

As shown in FIG. 2A, exemplary drift tube assembly 10 also comprises at least one removable tubular liner, such as exemplary removable tubular liners 15 and 16. Each removable tubular liner has a first liner end 18, a second liner end 19, an inner liner surface 24 facing an interior of the removable tubular liner, and an outer liner surface 25. Each of the removable tubular liners (e.g., exemplary removable tubular liners 15 and 16) is individually positionable within exemplary drift tube 14 so that outer liner surface 25 of each removable tubular liner extends along inner drift tube surface 22, and desirably covers substantially all of inner drift tube surface 22.

FIG. 2B depicts a view of components of exemplary drift tube assembly 10 of FIG. 2A assembled with one another. As shown in FIG. 28, exemplary removable tubular liner 15 is partially inserted into exemplary drift tube 14 so that outer liner surface 25 of removable tubular liner 15 extends along inner drift tube surface 22 of exemplary drift tube 14.

FIG. 3A depicts a cross-sectional view of exemplary drift tube assembly 10 shown in FIG. 2B along line A-A when first exemplary removable tubular liner 15 is inserted into exemplary drift tube 14. As shown in FIG. 3A, exemplary drift tube 14 has an outer diameter, dₒ, and an inner diameter, dᵢ. Exemplary removable tubular liner 15 is positioned within exemplary drift tube 14 so that outer liner surface 25 of removable tubular liner 15 extends along inner drift tube surface 22 of exemplary drift tube 14. Exemplary removable tubular liner 15 with liner thickness, Lₜ₁, provides an effective diameter, dₑ₁, through exemplary drift tube assembly 10 shown in FIG. 3A, wherein dₑ₁ is less than dᵢ. Typically, effective diameter, dₑ₁, is substantially the same along a length of exemplary drift tube assembly 10.

FIG. 3B demonstrates the ability to alter the inner cross-sectional flow area of exemplary drift tube assembly 10 by replacing first exemplary removable tubular liner 15 with second exemplary removable tubular liner 16. As shown in FIG. 3B, exemplary drift tube 14 has outer diameter, dₒ, and inner diameter, dᵢ. Exemplary removable tubular liner 16 is positioned within exemplary drift tube 14 so that outer liner surface 25 of removable tubular liner 16 extends along inner drift tube surface 22 of exemplary drift tube 14. Exemplary removable tubular liner 16 with liner thickness, Lₜ₂, provides an effective diameter, dₑ₂, through exemplary drift tube assembly 10 shown in FIG. 3A, wherein dₑ₂ is less than dᵢ and dₑ₁. Typically, effective diameter, dₑ₂, is substantially the same along a length of exemplary drift tube assembly 10.

Exemplary drift tube assembly 10 comprises at least one removable tubular liner (e.g., either of exemplary removable tubular liners 15 and 16 or both of exemplary removable tubular liners 15 and 16 alone or in combination with other removable tubular liners (not shown)). In some embodiments, exemplary drift tube assembly 10 comprises a set of removable tubular liners, wherein the set of removable tubular liners comprising two or more removable tubular liners (e.g., both of exemplary removable tubular liners 15 and 16 alone or in combination with other removable tubular liners (not shown)), and each removable tubular liner within the set of removable tubular liners (i) is positionable within exemplary drift tube 14 so that outer liner surface 25 extends along inner drift tube surface 22, and (ii) has an inner cross-sectional area that differs from other removable tubular liners within the set.

Each removable tubular liner (e.g., exemplary removable tubular liners 15 and/or 16) individually comprises an inert material, desirably a thermally conductive material. Suitable inert materials include, but are not limited to, inorganic materials such as metals, glass, ceramics, etc., organic materials including thermally conductive polymeric materials (e.g., filled polymers) such as carbon filled polyethylene (PE), polypropylene (P), polyester, polyetheretherketone (PEEK), and polytetrafluoroethylene (PTFE). In one desired embodiment, the removable tubular liner comprises stainless steal.

Each removable tubular liner (e.g., exemplary removable tubular liners 15 and/or 16) individually has an average liner thickness (e.g., Lₜ₁ or Lₜ₂) that varies depending on a number of factors including, but not limited to, the materials used to form a given removable tubular liner, and the desired inner cross-sectional fluid flow through exemplary drift tube assembly 10, exemplary drift tube 14, and a given removable tubular liner. Typically, a given removable tubular liner has an average liner thickness of from about 0.25 millimeters (mm) (0.01 inches (in)) to about 50.8 mm (2 in). In one exemplary embodiment, a set of removable tubular liners have a combined average liner thickness that ranges from a lower average liner thickness of about 0.25 mm (0.01 in) and an upper average liner thickness of about 50.8 mm (2 in).

Each removable tubular liner (e.g., exemplary removable tubular liners 15 and/or 16) individually has a liner length that varies depending on a number of factors including, but not limited to, the length of exemplary drift tube 14, and the lengths of other drift tubes used with the one or more removable tubular liners. Typically, each removable tubular liner has a liner length substantially equal to or greater than a length of a given drift tube.

As noted above, the use of a removable tubular liner (e.g., exemplary removable tubular liner 15 or 16) enables quick clean-up of a given drift tube (e.g., exemplary drift tube 14), as well as the ability to quickly and effectively change an inner cross-sectional flow area of a drift tube (e.g., exemplary drift tube 14) to increase or decrease fluid flow through the drift tube (e.g., exemplary drift tube 14) as desired for various applications. In addition, the use of a removable tubular liner (e.g., exemplary removable tubular liner 15 or 16) enables clean-up without the need to burn residual material from an interior surface of a given drift tube (e.g., interior surface 22 of exemplary drift tube 14). Moreover, the removable liner may also be disposable, which eliminates the need for cleaning. The resulting drift tube assembly (e.g., exemplary drift tube assembly 10 comprising exemplary drift tube 14 in combination with exemplary removable tubular liner 15 or 16) enables the construction of a detector, wherein the detector has a maximum operating temperature of at least about 150° C., and even at least about 200° C.

3. Cartridge

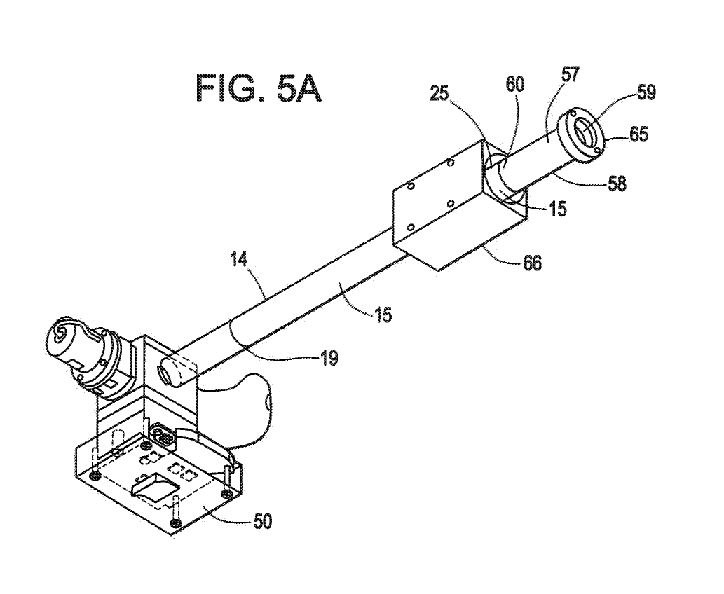

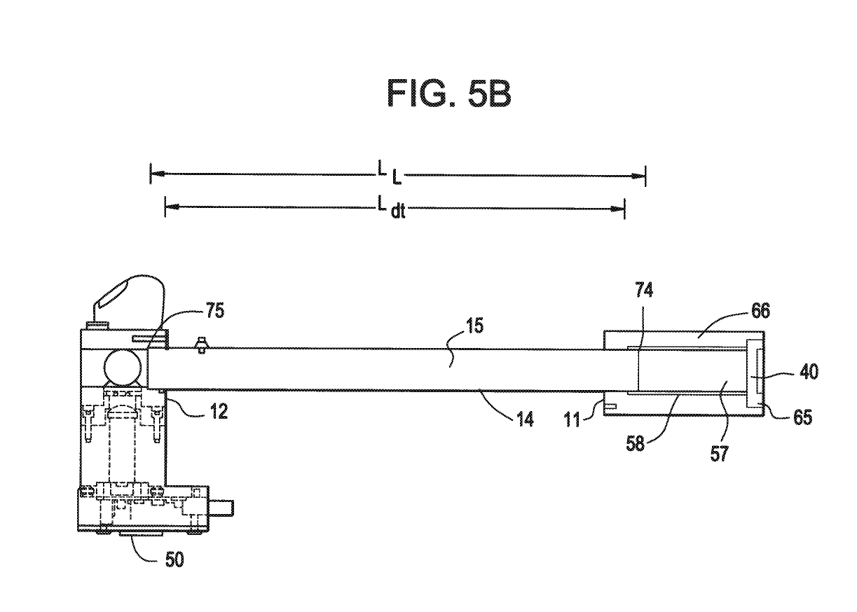

A given drift tube assembly may further comprise an optional cartridge assembly positioned between a nebulizer and a drift tube. An exemplary cartridge assembly and its use in combination with other drift tube assembly components is shown in FIGS. 4-5B. The disclosed cartridge assembly is particularly useful as a component in an ELSD apparatus.

As shown in FIG. 4, exemplary cartridge assembly 51 may comprise cartridge 58. Exemplary cartridge assembly 51 is shown in combination with the following additional device components: nebulizer 40, O-ring 56, screws 43 suitable for attaching exemplary cartridge 58 to tubular structure 13 of exemplary drift tube 14.

Exemplary cartridge 58 comprises cartridge insert 57, flange section 65, one or more tubular liner positioning members 61 (shown as screw holes 61 in FIG. 4) capable of temporarily securing a removable tubular liner (e.g., exemplary removable tubular liner 15 or 16) onto an end 63 of cartridge insert 57, and one or more screws 60 for extending through hole(s) 26 positioned along end 18 of exemplary removable tubular liner 15 and hole(s) 61 position along end 63 of cartridge insert 57. It should be noted that a given removable tubular liner (e.g., exemplary removable tubular liner 15 or 16) may be removable affixed along an outer surface 68 or an inner surface 59 of cartridge insert 57 (i.e., inner surface 24 of exemplary removable tubular liner 15 may be in contact with and over outer surface 68 of cartridge insert 57 or, alternatively, outer surface 25 of exemplary removable tubular liner 15 may be in contact with and over inner surface 59 of cartridge insert 57).

Exemplary cartridge 58 may be sized so as to be suitable for use with a given drift tube, including exemplary drift tube 14. Cartridge insert 57 is sized so as to be extendable within an opening 42 at first end 11 of tubular structure 13 along inner wall surface 22 of tubular structure 13 within drift tube 14. As shown in FIG. 4, cartridge insert 57 may be positioned between nebulizer 40 and tubular structure 13 such that nebulizer 40 may be removably attached to cartridge 58 by screws (not shown) or by any other attachment member. Cartridge assembly 51 may be removably attached to tubular structure 13 by any suitable attachment member, including, but not limited to, screws 43 suitable for being received by holes 44 within flange 65 of exemplary cartridge 58 and then by holes 45 in tubular structure 13.

It should be noted that the overall length of exemplary cartridge 58 can vary depending on a number of factors including, but not limited to, the overall length of drift tube 14, whether an optional cartridge housing is also utilized (shown in FIGS. 5A-5B), the overall length of a cartridge housing when used with cartridge 58 and drift tube 14, and the test sample composition to be tested. When connected directed to drift tube 14, exemplary cartridge 58 typically has a minimal length of less than about 7.62 cm (3.00 in). When a cartridge housing is utilized, exemplary cartridge 58 typically has a length of less than the overall length of the cartridge housing and typically less than about 60.96 cm (24.00 in).

As shown in FIG. 4, exemplary cartridge 58 may further comprise flange 65 suitable for connecting exemplary cartridge 58 to other device components, such as drift tube 14. In one exemplary embodiment, flange 65 is used to connect exemplary cartridge 58 to a drift tube 14. In another exemplary embodiment, flange 65 is used to connect exemplary cartridge 58 to a cartridge housing (as shown in FIGS. 5A-5B).

In one embodiment of the present invention, flange 65 is formed as an integral part of exemplary cartridge 58. Such a configuration is shown in exemplary cartridge assembly 51 shown in FIGS. 4-5B. In other embodiments, flange 65 may be a separate cartridge component that is fixed onto one end of cartridge insert 57. Regardless of construction, flange 65 comprises one or more structural features so as to enable flange 65 to be connected to any other apparatus component. Suitable structural features include, but are not limited to, bolts extending from a surface of the flange, threaded holes within the flange, pipe threads, compression fittings, connectors, etc.

Cartridge 58 may comprise one or more materials, desirably one or more inert materials. Suitable materials for forming cartridge 58 include, but are not limited to, metals such as aluminum, stainless steel and titanium; polymeric materials such as polyetheretherketone (PEEK), and polytetrafluoroethylene (PTFE); glasses including borosilicate glass; and ceramic materials. In one exemplary embodiment of the present invention, cartridge 58 comprises a metal selected from aluminum and stainless steel. In a desired embodiment, cartridge 58 comprises stainless steel such as 316L stainless steel.

Cartridge insert 57 of cartridge 58 may have an average wall thickness that varies depending on a number of factors including, but not limited to, the inner diameter of a given drift tube (e.g., exemplary drift tube 14), the desired structural integrity of cartridge insert 57, etc. Typically, cartridge insert 57 has an average wall thickness of from about 0.10 mm (0.004 in) to about 50.8 mm (2 in). In one exemplary embodiment, cartridge insert 57 comprises stainless steel and has an average wall thickness of about 2.54 mm (0.10 in) to about 10.16 mm (0.40 in) (more desirably, about 6.35 mm (0.25 in)).

4. Cartridge Housing

A given cartridge assembly may further comprise a cartridge housing, which acts as a connector between a nebulizer (e.g., exemplary nebulizer 40) and a drift tube (e.g., exemplary drift tube 14). FIGS. 5A-5B depict an exemplary configuration comprising an exemplary cartridge housing component.

As shown in FIG. 5A, exemplary tubular liner 15 is attached to exemplary cartridge 58 via screw 60, and extends through cartridge housing 66 and into exemplary drift tube 14 (i.e., exemplary drift tube 14 is shown as a clear tube so that exemplary tubular liner 15 can be seen). In this exemplary embodiment, exemplary tubular liner 15 is attached to exemplary cartridge 58 so that outer surface 25 of exemplary tubular liner 15 contacts inner surface 59 of exemplary cartridge 58.

FIG. 5B depicts a cross-sectional view of exemplary tubular liner 15 attached to exemplary cartridge 58, wherein exemplary cartridge 58 is fully inserted into cartridge housing 66 and exemplary tubular liner 15 is fully inserted into exemplary drift tube 14. As shown in FIG. 5B, exemplary tubular liner 15 extends from point 74 within cartridge housing 66 to point 75 within optics block 50 along a complete length, L_{dt}, of exemplary drift tube 14. In this exemplary embodiment, exemplary tubular liner 15 has a length, L_{L}, slightly greater than the length, L_{dt}, of exemplary drift tube 14.

C. Active Condensate Drain Trap

The present invention is further directed to an active condensate drain trap. As used herein, the terms “active” or “actively” are used to describe condensate drain traps that capture and dispose of condensate with minimal, and desirably, no operator intervention. The disclosed active condensate drain traps may utilize a condensate pump or an evaporation-promoting material to dispose of captured condensate. Further, as used herein, “condensate” is used to refer to material that exits optics block 50.

Active condensate drain traps of the present invention may be positioned within a device, such as a detector housing of a detector. Typically, active condensate drain traps of the present invention are positioned within a device, such as a detector housing of a detector, so as to free up lab space and minimize potential safety hazards. Each active condensate drain trap is operatively adapted to be actively drained via a condensate pump or an evaporator positioned within the device (e.g., the detector housing).

As shown in FIG. 1, exemplary active condensate drain trap 30 is positioned downstream from optics block 50, and is positioned along a detector housing wall 103. Exhaust opening 31 extends from exemplary active condensate drain trap 30 through detector housing wall 103. Exhaust leaves exemplary active condensate drain trap 30 through opening 31 as shown by arrow E. Condensate pump 32 actively removes condensate (not shown) that accumulates within active condensate drain trap 30 through drain opening 35, along arrow C, though condensate pump 32, and along arrow D to a waste disposal container or line (not shown).

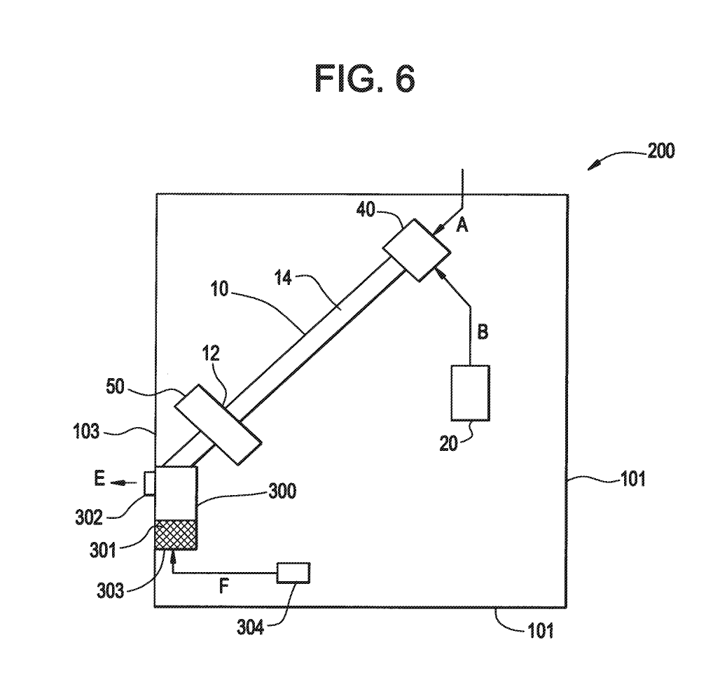

In an alternative embodiment shown in FIG. 6, exemplary detector 200 comprises a detector housing 101 and the following components positioned within detector housing 101: drift tube assembly 10, air pump 20, nebulizer 40, optics block 50, active condensate drain trap 300, and evaporation-promoting material 301. In exemplary detector 200, condensate exiting optics block 50 is trapped within active condensate drain trap 300.

In exemplary detector 200, condensate (not shown) enters active condensate drain trap 300 and accumulates on an evaporation-promoting material 301 positioned within active condensate drain trap 300. Suitable evaporation-promoting materials 301 comprise any inert material having a relatively high amount of surface area per volume of material, and desirably, a wicking property (e.g., condensate contacts and moves away from an outer surface and into voids of evaporation-promoting material 301). Exemplary evaporation-promoting materials 301 include, but are not limited to, nonwoven fabrics, mesh fabrics, foam materials, microporous materials, etc. typically formed from porous ceramics, sintered metals, porous glass, and polymeric material. In one desired embodiment, evaporation-promoting material 301 comprises a polyethylene nonwoven fabric material.

Exemplary active condensate drain trap 300 may further comprise a gas inlet 303 that enables a gas (e.g., air) to flow through evaporation-promoting material 301 and further increase evaporation of condensate within exemplary active condensate drain trap 300. Exemplary active condensate drain trap 300 may further comprise a gas-flow enhancer 304 that forces gas (e.g., air) along arrow F into gas inlet 303 and through evaporation-promoting material 301 and exemplary active condensate drain trap 300. Any gas-flow enhancer 304 may be used as long as gas-flow enhancer 304 is operatively adapted to increase gas flow through exemplary active condensate drain trap 300. Suitable gas-flow enhancers 304 include, but are not limited to, a fan. Although not shown in FIG. 6, an air stream from air pump 20 could be routed into gas inlet 303 and through evaporation-promoting material 301 and exemplary active condensate drain trap 300.

It should be noted that exemplary active condensate drain trap 300 is also positioned downstream from optics block 50, and is positioned along a detector housing wall 103. Exhaust opening 302 extends from exemplary active condensate drain trap 300 through detector housing wall 103. Exhaust leaves exemplary active condensate drain trap 300 through opening 302 as shown by arrow E.

In an alternative embodiment according to the present invention, the active drain trap 30 may include a level sensor (not shown) that activates condensate drain pump 32 when the level of liquid in the drain trap 30 reaches a certain level as shown in FIG. 1.

### II. Methods of Making Components

The present invention is also directed to methods of making the above-described components of the present invention. Each of the above-described components may be prepared using conventional techniques. For example, in one exemplary method of making a drift tube assembly, the method may comprise forming a drift from an inert material (e.g., stainless steel) using a metal casting process step, and optionally surrounding the tubular member with one or more outer layers. Outer layers may be coated onto an outer surface of the tubular member using, for example, a metal sputtering step, or may be preformed using a molding or casting step, and subsequently fitted over an inner layer. Metal casting steps may also be used to form cartridge 58. Components comprise a polymeric material, such as each of the removable tubular liners, may be formed using any conventional thermoforming step (e.g., injection molding, cast molding, etc.).

Methods of making one or more of the above-described devices of the present invention may comprise incorporating one or more of the above-described components of the present invention into a device, such as a device housing of the device. For example, methods of making a device may comprise incorporating one or more of the above-described components of the present invention into a device operatively adapated to perform an analytical test method step or steps, such as a method of analyzing a test sample that potentially contains at least one analyte.

In one exemplary embodiment, the method of making a device of the present invention comprises a method of making a detector suitable for use in chromatography applications, wherein the method comprises incorporating (1) an air pump (e.g., exemplary air pump 20) within a detector housing (e.g., exemplary detector housing 101) of the detector (e.g., exemplary detector 100 or 200), the air pump being operatively adapted to supply compressed air to a nebulizer (e.g., exemplary nebulizer 40) positioned within the detector housing; (2) a drift tube assembly (e.g., exemplary drift tube assembly 10) within the detector housing (e.g., exemplary detector housing 101), wherein the drift tube assembly comprises (i) a drift tube (e.g., exemplary drift tube 14) having a first end, a second end, an inner drift tube surface facing an interior of said drift tube, and an outer surface; and (ii) at least one removable tubular liner (e.g., exemplary removable tubular liner 15 alone or in combination with other removable tubular liners), each removable tubular liner having a first liner end, a second liner end, an inner liner surface facing an interior of the removable tubular liner, and an outer liner surface, wherein each of the removable tubular liners is positionable within the drift tube so that the outer liner surface of the removable tubular liner extends along the inner drift tube surface; (3) an active condensate drain trap (e.g., exemplary active condensate drain trap 30 or 300) within the detector housing (e.g., exemplary detector housing 101), the active condensate drain trap being operatively adapted to actively drain via a condensate pump (e.g., exemplary condensate pump 32) or an evaporation-promoting material (e.g., exemplary evaporation-promoting material 301) positioned within the detector housing; or (4) any combination of (1) to (3).

### III. Methods of Using Components

The present invention is further directed to methods of using one or more of the above-described components of the present invention, as well as one or more of the above-described devices of the present invention. Methods of using one or more of the above-described components of the present invention may comprise using one or more of the above-described components within a device, for example, a device operatively adapated to perform an analytical test method step or steps, such as a method of analyzing a test sample that potentially contains at least one analyte.

In one exemplary embodiment, the method of using one or more of the above-described components of the present invention comprises using one or more of the above-described components within a detector, such as an evaporative light scattering detector (ELSD), and using the ELSD in a flash chromatography system.

In desired embodiments, one or more of the above-described components are used in an analytical device, such as an ELSD apparatus, in order to analyze a test sample. In one exemplary embodiment, the method comprises a method of analyzing a test sample that potentially contains at least one analyte, wherein the method comprises the steps of introducing the test sample into a device comprising (1) an air pump (e.g., exemplary air pump 20) within a detector housing (e.g., exemplary detector housing 101) of the detector (e.g., exemplary detector 100 or 200), the air pump being operatively adapted to supply compressed air to a nebulizer (e.g., exemplary nebulizer 40) positioned within the detector housing; (2) a drift tube assembly (e.g., exemplary drift tube assembly 10) within the detector housing (e.g., exemplary detector housing 101), wherein the drift tube assembly comprises (i) a drift tube (e.g., exemplary drift tube 14) having a first end, a second end, an inner drift tube surface facing an interior of said drift tube, and an outer surface; and (ii) at least one removable tubular liner (e.g., exemplary removable tubular liner 15 alone or in combination with other removable tubular liners), each removable tubular liner having a first liner end, a second liner end, an inner liner surface facing an interior of the removable tubular liner, and an outer liner surface, wherein each of the removable tubular liners is positionable within the drift tube so that the outer liner surface of the removable tubular liner extends along the inner drift tube surface; (3) an active condensate drain trap (e.g., exemplary active condensate drain trap 30 or 300) within the detector housing (e.g., exemplary detector housing 101), the active condensate drain trap being operatively adapted to actively drain via a condensate pump (e.g., exemplary condensate pump 32) or an evaporation-promoting material (e.g., exemplary evaporation-promoting material 301) positioned within the detector housing; or (4) any combination of (1) to (3). In this exemplary method, desirably the device used in the method is an evaporative light scattering detector (ELSD), and the ELSD is used in a flash chromatography system.

In a further exemplary embodiment, the method of analyzing a test sample comprises utilizing a drift tube assembly (e.g., exemplary drift tube assembly 10), wherein the method comprises substituting a second removable tubular liner (e.g., exemplary removable tubular liner 16) for a first removable tubular liner (e.g., exemplary removable tubular liner 15) to alter an inner cross-sectional flow area of the drift tube assembly (e.g., exemplary drift tube assembly 10). This exemplary method may further comprise (i) nebulizing a first test sample to form a first aerosol of particles within a mobile phase, and allowing the first aerosol of particles to flow through the first removable tubular liner prior to the substituting step; (ii) nebulizing a second test sample to form a second aerosol of particles within a mobile phase, and allowing the second aerosol of particles to flow through the second removable tubular liner after the substituting step; or both steps (i) and (ii).

The above exemplary methods of analyzing a test sample may further comprise any of the following step: nebulizing the test sample to form an aerosol of particles within a mobile phase; utilizing air to nebulize the test sample and form an aerosol of particles within a mobile phase; optionally removing a portion of the particles prior to introducing the test sample into the drift tube; evaporating a portion of the mobile phase along length L of the drift tube; directing a light beam at the remaining particles so as to scatter the light beam; detecting the scattered light; analyzing data obtained in the detecting step; collecting condensate that exits an optics block (e.g., optics block 50); and actively draining condensate trapped in an active condensate drain trap (e.g., exemplary active condensate drain trap 30 or 300).

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

A Reveleris™ Flash Chromatography System equipped with an ELSD, air pump, active drain trap and removable drift tube liner was configured as follows:

(a) Drift tube temperature 30 C

(b) Nebulizer air flow (supplied by internal air pump) 3 L/minute

(c) ELSD carrier flow of 250 uL/minute of isopropyl alcohol

(d) Active condensate drain trap

(e) Pump to deliver condensate to waste

A 2 mL sample of 100 mg/mL butyl paraben was injected 50 times onto a 12 g Reveleris™ silica cartridge using a 80/20 hexane/ethyl acetate mobile phase at 25 mL/min. During the analyses the air pump supplied nebulizer gas without the need for an external gas source. The active condensate trap effectively trapped isopropyl alcohol and sample material that condensed upon existing the ELSD optics block. The condensate pump delivered the condensate from the trap to a waste container outside the instrument. After the 50 analyses were complete, the ELSD drift tube liner was removed and the sample residue build up was cleaned out of the drift tube using a wire brush. The drift tube liner was reinstalled.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}k(R_{U}−R_{L}), where k is a variable ranging from 1% to 100% with a 1% increment, e.g., k is 1%, 2%, 3%, 4%, 5%. . . . 50%, 51%, 52%. . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

What is claimed is:

1. A detector suitable for use in chromatography applications, said detector comprising:
(a) a detector housing;
(b) a nebulizer positioned within said detector housing; and
(c) an air pump positioned within said detector housing, said air pump being operatively adapted to supply compressed air to said nebulizer.

2. The detector of claim 1, wherein said air pump converts atmospheric air to the compressed air.

3. The detector of claim 1, further comprising:
(a) a drift tube assembly, said drift tube assembly comprising:
(b) a drift tube having a first end, a second end, an inner drift tube surface facing an interior of said drift tube, and an outer surface; and
(c) at least one removable tubular liner, each removable tubular liner having a first liner end, a second liner end, an inner liner surface facing an interior of said removable tubular liner, and an outer liner surface, each of said removable tubular liners being positionable within said drift tube so that said outer liner surface extends along said inner drift tube surface.

4. The detector of claim 3, wherein said at least one removable tubular liner comprises a set of removable tubular liners, said set of removable tubular liners comprising two or more removable tubular liners, and each removable tubular liner within said set of removable tubular liners (i) is positionable within said drift tube so that said outer liner surface extends along said inner drift tube surface, and (ii) has an inner cross-sectional area that differs from other removable tubular liners within said set.

5. The detector of claim 3, wherein said at least one removable tubular liner is positioned within said drift tube so as to cover substantially all of said inner drift tube surface.

6. The detector of claim 3, wherein said removable tubular liner has a liner length substantially equal to or greater than a length of said drift tube.

7. The detector of claim 3, wherein said detector has a maximum operating temperature of at least about 150° C.

8. The detector of claim 1, further comprising:
(a) an active condensate drain trap positioned within said detector housing.

9. The detector of claim 3, further comprising:
(a) an active condensate drain trap positioned within said detector housing.

10. The detector of claim 4, further comprising:
(a) an active condensate drain trap positioned within said detector housing.

11. The detector of claim 1, wherein said detector comprises an evaporative light scattering detector.

12. A flash chromatography system comprising the detector of claim 1.

13. A drift tube assembly comprising:
(a) a drift tube having a first end, a second end, an inner drift tube surface facing an interior of said drift tube, and an outer surface; and
(b) at least one removable tubular liner, each removable tubular liner having a first liner end, a second liner end, an inner liner surface facing an interior of said removable tubular liner, and an outer liner surface, each of said removable tubular liners being positionable within said drift tube so that said outer liner surface extends along said inner drift tube surface.

14. The drift tube assembly of claim 13, wherein said at least one removable tubular liner comprises a set of removable tubular liners, said set of removable tubular liners comprising two or more removable tubular liners, and each removable tubular liner within said set of removable tubular liners (i) is positionable within said drift tube so that said outer liner surface extends along said inner drift tube surface, and (ii) has a tubular liner thickness that differs from other removable tubular liners within said set.

15. The drift tube assembly of claim 13, wherein each removable tubular liner of said at least one removable tubular liner has a liner length substantially equal to or greater than a length of said drift tube.

16. The drift tube assembly of claim 13, wherein each removable tubular liner of said at least one removable tubular liner comprises a thermally conductive material, and said drift tube comprises at least one metallic material.

17. The drift tube assembly of claim 13 in combination with a nebulizer, a light source, a photodetector, an active condensate drain trap, or any combination thereof.

18. The drift tube assembly of claim 13, in combination with a nebulizer attached to said first end, and (i) a light source, and (ii) a photodetector positioned proximate to said second end.

19. The drift tube assembly of claim 18, further comprising:
(a) an active condensate drain trap positioned downstream from (i) said drift tube, (ii) said light source, and (iii) said photodetector.

20. An evaporative light scattering detector comprising the drift tube assembly of claim 13.

21. A flash chromatography system comprising the evaporative light scattering detector of claim 20.

22. A detector suitable for use in chromatography applications, said detector comprising:
(a) a detector housing; and
(b) an active condensate drain trap positioned within said detector housing, said active condensate drain trap being operatively adapted to actively drain via a condensate pump or an evaporator positioned within said detector housing.

23. The detector of claim 22, wherein said active condensate drain trap comprises a condensate pump positioned within said detector housing.

24. The detector of claim 22, wherein said active condensate drain trap comprises an evaporation-promoting material positioned within said active condensate drain trap.

25. The detector of claim 24, further comprising a gas-flow enhancer operatively adapted to increase gas flow through said active condensate drain trap.

26. The detector of claim 22, wherein said detector comprises an evaporative light scattering detector.

27. A flash chromatography system comprising the detector of claim 22.

28. (canceled)
